(19) United States
(12) Patent Application Publication
(10) Pub. No.: US 2006/0267397 A1
(43) Pub. Date: Nov. 30, 2006

(54) Rim for bicycles and the like

(75) Inventors: Gerald Possarnig, Graz (AT); Manfred Hermann, Ligist (AT); Friedrich Sackl, Stallhofen (AT)

Correspondence Address: BIRCH STEWART KOLASCH & BIRCH, PO BOX 747, FALLS CHURCH, VA, 22040-0747, US

(73) Assignee: XENTIS Composite Produktions- & Handels Ges.m.b.H. & Co. KG., Koflach (AT)

(21) Appl. No.: 11/282,279

(22) Filed: Nov. 18, 2005

Related U.S. Application Data
(63) Continuation of application No. PCT/AT04/00176, filed on May 19, 2004.

(30) Foreign Application Priority Data
May 21, 2003 (AT) A 788/2003

(51) Int. Cl. B60B 21/00

(52) U.S. Cl. 301/95.102

(57) ABSTRACT

The present invention relates to a rim for bicycles and the like, comprising at least one braking area on at least one flank of the rim for placing a braking member, said braking area essentially consisting of fibre-reinforced plastic. The rim according to the invention is characterized in that the surface of the braking area exhibits an amount of reinforcing fibre of more than 10%.

The present invention relates to a rim for bicycles and the like, which comprises a braking area on at least one flank for placing a braking member, said braking area essentially consisting of fibre-reinforced plastic.

Fibre-reinforced composite materials are used in single-track or double-track vehicles of a lightweight design, which are driven by muscular power, such as bicycles for one or several persons (tandems), vehicles for the disabled (wheelchairs) or means of transport (pushcarts, wheelbarrows). Thereby, the properties of high strength and dimensional stability, combined with a low structural weight, are made use of. If these vehicles have a lightweight design, fibre composites are used instead of the metal components such as the framework, rims, spokes and hubs.

The processes used for producing the original models made of fibre-reinforced plastic comprise: primary shaping by impregnating, winding, drawing, laminating, casting, batching, pressing, heating and cooling plastic-bonded fibres.

Typical semifinished reinforcing fibre products for the manufacture are, for example, fabrics, interlacings or layer arrangements (cross-plies, lap rolls) made of geometrically arranged fibre-plastic bonds. Duroplastic and thermoplastic synthetic materials bind the reinforcing fibres from carbon, graphite, silicate glass or polymers. Foamed filling material are likewise used.

Rims made of compression-moulded fibre-reinforced composite materials suffer from problems with detrimental wear properties of the braking area on the rim flanks, compared to rims made of steel or aluminium.

In the prior art, such disadvantages are avoided by means of various pre- or aftertreatment processes. Known technologies are: the connection with aluminium rim parts, the application of aluminium layers (aluminium sheet); metal plating; hard materials (TiO₂, ZrO₂, Al₂O₃, metal or diamond particles) interspersed in the synthetic surface material; flame-sprayed hard-material application (enamelling/ceramics).

DE 10127908 describes a process for the production of a chemical-resistant protective layer for solids of rotation comprising a base made of fibre-reinforced plastic and for other solids of rotation.

A plurality of prior art documents (DE 19739291C1, DE 3935133C2, DE 19922799A1, DE 4215756A1) describe processes for the production of fibre-reinforced plastics.

In standard manufacturing technologies, fibre-depleted surface layers are formed by the primary shaping process, since prior to curing the plastic material, still in the liquid form, is pressed against the surface while the fibres contact the surface only in a point- or line-shaped manner. The reinforcing fibres (normally carbon fibres) are properly integrated in the duroplastic or thermoplastic synthetic materials.

Disadvantages of the above-described prior art are: Besides the unfavourable abrasion properties of untreated synthetic surface layers (artificial resin layer), which require specific cork or cork-containing brake linings, various (inhomogeneous) material properties (coefficient of thermal expansion, torsion stiffness, modulus of elasticity) cause flaking, detachments or the formation of breaks (cracks) in the surface coatings of additionally applied layers.

In the prior art, surface refining processes for improving the chemical or weathering resistance of fibre-reinforced plastics are always effected by the application of layers (by electroplating, lamination, mechanical connection with aluminium layers) on the base made of a fibre-reinforced composite material (after or during the primary shaping of the fibre-fleece assembly).

The applied layers are usually treated further, for example, by polishing, levelling. Specific importance is attached to the effective range of the brake linings. Separate wear indicator cavities are mounted for indicating the rim abrasion. The German Standard DIN79100 demands wear indicators for rims having diameters larger than 500 mm.

It is the object of the present invention to provide a rim of the initially described kind comprising one or several braking areas, which meets the above-indicated conditions in terms of its properties and does not exhibit the above-described disadvantages of the prior art.

Said object is achieved by means of the rim according to claim 1. Further preferred embodiments of the rim according to the invention are described in claims 2 to 5.

A process for the manufacture of the rim according to the invention as well as preferred embodiments thereof are described in claims 6 to 14.

The rim according to the invention differs from prior art rims in terms of the braking area in that, rather than applying an additional layer of a suitable material to the braking area, the desired properties of the braking area are achieved in that the surface of the braking area exhibits a certain amount of reinforcing fibres of the fibre-reinforced plastic.

As mentioned above, original models made of fibre-reinforced plastic usually comprise, as a result of the production process, a layer on their surface, which layer contains hardly any reinforcing fibres and consists virtually exclusively of the polymer matrix which exhibits inadequate wear properties. By removing said layer, the reinforcing fibres located in the interior of the original model are exposed, i.e., cross-sections of the reinforcing fibres form on the surface, which may adopt different shapes (circular sections, elliptic sections) depending on the orientation of the fibres in the polymer matrix.

The amount of reinforcing fibres thereby resulting on the surface of the braking area which, according to the invention, amounts to more than 10% of the surface (regarding the method of determining said amount: see below) has the effect that, in terms of the required properties, the braking area meets the above-mentioned requirements perfectly, in particular with regard to the brake reaction and the wear characteristics.

During the removal of the material of the braking area, parts of the reinforcing fibres or bundles of reinforcing fibres that are used are cut transversely, longitudinally and/or obliquely to the fibre axis. The micro cross-sections thus arising form a surface together with the strongly reduced amounts of composite material made of plastic, with the properties of said surface being determined primarily by the physical properties of the fibres.

In order to determine which amount of reinforcing fibres is contained in the surface of the braking area, the surface is analyzed optically. All image-reproducing processes (optical microscopy, scanning electron microscope etc.) by means of which a sufficient contrast between the cross-sections of the reinforcing fibres and the polymer matrix can be achieved are suitable for this purpose. This can be facilitated by treating the surface (purification, etching, but not cutting).

The optical picture of the surface can be converted into a computer-processable data format (pixel scan) via methods known per se and can be evaluated with the aid of a computer. The pixel scan displays different grey tones for the reinforcing fibre and for the polymer matrix. By manually determining a threshold value, a distinction is made between the fibre area and the matrix area. A digitally coded pixel image is then obtained (current image-editing programs provide this possibility as a standard). Using an algorithm, the bounds between the contrast surfaces are scanned. The result is a closed irregular outline for each fibre passage through the cut surface.

Under the assumption that the reinforcing fibres have a roughly circular cross-section, the theoretical curve through the cut surface must be an ellipse if the fibre is cut obliquely, with the small principal axis corresponding to the fibre diameter. The free parameters of the ellipse—a large principal axis and the angle of the principal axis—are determined according to the compensation principle of the method of the smallest error squares introduced by C. F. Gauss (17^{th} century).

In doing so, the ellipses exhibiting the smallest deviation from the pixel outlines are searched for.

The area proportion of the fibre sections then results from the proportion of elliptical areas based on the viewing area. Ellipses the principal axes of which are smaller than the fibre diameter constitute impurities (fragments) and thus cannot be taken into account.

The reinforcing fibres have a typical diameter of, e.g., 5 μm (carbon fibre) and 14 μm (glass fibre), respectively.

In the process according to the invention, in contrast to all current processes,
the rim flanks are subjected to an erosive (material-removing) treatment,
the braking area is manufactured and shaped preferably by means of cutting tools
whereby defined properties (brake reaction, hard wearing properties) arise

Similar processes for the treatment of carbon-fibre composite materials are used in the field of aerospace and aeronautical engineering for shaping and in the manufacture of brake disks for motor vehicles.

The improvements over the prior art as a result of the present invention are provided by the homogeneous physical properties of the base material and the material surface of the rims or running wheels thus produced and treated, the good abrasion resistance, heat conduction and braking properties, the saving on lamination operations and similar operations of material application, and consequently the elimination of all sorts of detachment processes such as, for instance, flaking of the layers due to different coefficients of thermal expansion.

The material-removing treatment of the rim base carries fibre cross-sections of the reinforcing fibres right to the surface of the rim. The treatment is preferably performed on both rim flanks and precisely parallel with regard to the direction of rotation of the wheel so that the brake linings are always subjected to a constant brake resistance. Vibrations are avoided as far as possible, and the abrasion resistance is constant throughout the entire circumference. The high density of reinforcing fibres produces an extremely hard low-wear zone in the effective range of the brake. Furrows which possibly may be introduced serve for a better behaviour under wet conditions or as an indicator.

The surface has a direct connection with the basic structure of the body, disturbing plastic (artificial resin) layers prone to wear are removed partially or completely by the treatment process. At the same time, the quality of shaping becomes visible via the preproduction steps, the quality of primary shaping is reflected in the surface. The quality of the lamination process and of the preceding primary shaping process reveals itself in the surface structure, whereby measuring and control possibilities for quality assurance are created. This is another difference to coating technologies wherein coatings conceal the nature of the base material.

The manufacturing technologies for the production of original models are not explained in detail here, basically, however, all common processes for the production of fibre-reinforced composite materials are feasible, which contain basic compositions of continuous graphite, carbon, coal, silicate and polymer fibres and thermoplastic or duroplastic base materials.

A homogeneous nature of the plastic-fibre matrix of the braking area which is as consistent as possible throughout the entire circumference of the original rim model is favourable for carrying out the above-mentioned invention.

The fibre-reinforced plastic of the braking area preferably comprises as reinforcing fibres or fibre fabrics, respectively, those from the group comprising natural and synthetic fibres, in particular from carbon (carbonado, graphite), glass, aramide, ceramic base materials such as boron nitride, silicium carbide or silicate, or combinations of these fibres. They can be used in the form of fabrics, lap rolls or cross-plies made of such fibres which have been impregnated with a liquid or solidified (consolidated) plastic material.

Examples of fibre assemblies are lap roll patterns with large numbers of patterns, i.e., many overlaps, plait patterns and basket laps. The clearances are filled with the impregnation material. Via the subsequent consolidation processes under pressure and heating, the reinforcing fibres solidify by fusing with the amount of plastic material.

The synthetic material forming the matrix of the fibre-reinforced plastic is preferably selected from the group comprising thermoplastic plastic materials such as modified natural substances, homo- and copolymers or polymer blends of cellulose nitrate, cellulose acetate, cellulose ether or cellulose mixed ether, polyamides, polycarbonates, polyester, polyvinyl ester, polyolefins, polyphenylene oxides, ionomers, polysulfones, polyvinyl acetals, polyvinyl chloride, polyvinylidene chloride, polyvinyl alcohol, vinyl ester, polymethyl methacrylate, chlorinated polyether, polyacrylonitrile, polystyrene, polyacetals, fluorocarbon plastics, polyvinyl acetate, polyetherketones, acrylonitrile, styrene-butadiene copolymers, styrene-acrylonitrile copolymers, polyterephthalates, linear polyurethanes, polyethylene (PE), polypropylene and polyamide and/or thermosetting materials such as casting resins from epoxy resin, methacrylate resin, phenacryle resin, polyester resin, phenolic resin, isocyanate resin, melamine-formaldehyde resin, vinyl ester as well as polyurethanes with a polymer, monomer structure or as a hybrid, as well as hybrids of thermoplastic and duroplastic synthetic materials.

The amount of reinforcing fibres in the total volume of fibre-reinforced plastic may amount to between 10% and 90%, the assembly can be arranged in layers or woven. Framework structures with foamed synthetic materials, filled cavities, defined corrugations for increasing the stability or vacuum and honeycomb techniques may also be used in order to achieve further weight savings or increases in stiffness.

The employed plastic materials and reinforcing fibres suitably exhibit a decomposition temperature or glass-transition temperature, respectively, which is higher than the temperatures occurring in the braking process.

Possible additives in the synthetic material are soot particles, MoS particles, particles of titanium or zirconium oxides, of Al₂O₃, oxide mixtures as well as carbides such as SiC and B₄C, boron nitride, diamond as well as mixtures of these materials.

Following the processing of the original model and complete curing under pressure and heating, the surface of the flank of the rim or of the running wheel made of fibre-reinforced plastic is subjected to mechanical refinement. In this state, there is usually an excess amount of plastic on the outermost layers of the still untreated rim.

According to the invention, the outer layers of the fibre composite are subsequently removed mechanically via a cutting or erosive treatment, resulting in a defined removal of the exterior of the excess amount of plastic and fibre fleece.

In doing so, the surface treated in this manner receives a structure made up of a predominant amount (preferably >50%) of reinforcing fibre material and a minimum amount of plastic material.

Depending on the layering (weaving, batching technique) of the fibre composite preproducts (e.g. semifinished reinforcing fibre sheet product) and their arrangement in the primary shaping process, fibre surface bundles lie in particular orientations in the surface.

A portion of the fibres is cut through completely when removing the material, and the fibre cross-section which is normal to the fibre axis forms a microelement of the surface. Other sections of parallel fibre bundles are cut in the longitudinal direction, wherein, in the ideal case, the largest possible amount contributes to the surface. The orientation of these fibre bundle surfaces has the same regularity as the fibre arrangement in the original interlacing or cross-ply.

The arrangement of the orientation of the interlacing or cross-ply can be in a radial direction and/or in a direction orthogonal thereto, it may have a particular angle relative to the radial direction (e.g. 90°) or may occur at random. The more rotationally symmetrical the arrangement of the fibres, the more regular will the braking properties around the entire circumference be. Furthermore, the roughness or smoothness, respectively, of the surface will be determined by the type of mechanical treatment; furrows for enhancing the braking properties under wet conditions are possible as well.

Preferably, the treatment technique of the process according to the invention is taken into account already in the primary shaping process. The required addition of semifinished reinforcing fibre products, the ideal orientation relative to the directions of treatment and brake power, and the refining of the consolidation process in the area of the surface to be treated are preferably adjusted to the subsequent process according to the invention.

The consolidation of the base materials should be effected via suitable pressure and temperature conditions especially in the area of the rim so that a sufficient and homogeneous formation of the structure is ensured. The shaping of the rim preferably occurs at a pressure of from 0.5 to 1000 bar and by heating the mould.

The removal according to the invention of the material of the braking area may be effected by cutting with a geometrically defined or undefined cutting edge. In the first case, turning, milling, filing and scraping are preferably suitable for preparing the braking area, in the latter case, the respective methods are, e.g., grinding, belt grinding, honing, vibratory grinding, super-finishing, lapping, jet cutting and polishing.

Rims according to the invention are suitable for being used in rims or running wheels of a lightweight design made of fibre-reinforced composite materials. Accordingly, the present invention, in a further aspect, relates to the use of the rims according to the invention in a single-track or multi-track vehicle driven by muscular power, selected from the group comprising bicycles such as road racing bicycles, mountain, city or tracking bikes or tandems, wheelchairs, pushcarts or wheelbarrows, scooters, tricycles, and/or in motor-driven small or lightweight vehicles selected from the group comprising electric vehicles, solar power vehicles, vehicles for the disabled, mopeds and motor-assisted bicycles.

It has been shown that, when using the rims according to the invention in the above-mentioned fields of application, a good dissipation of the heating is produced by the braking effect, the wear of the surface is extremely low and limited primarily to the (rubber) brake linings.

The present invention is illustrated by way of the following figures.

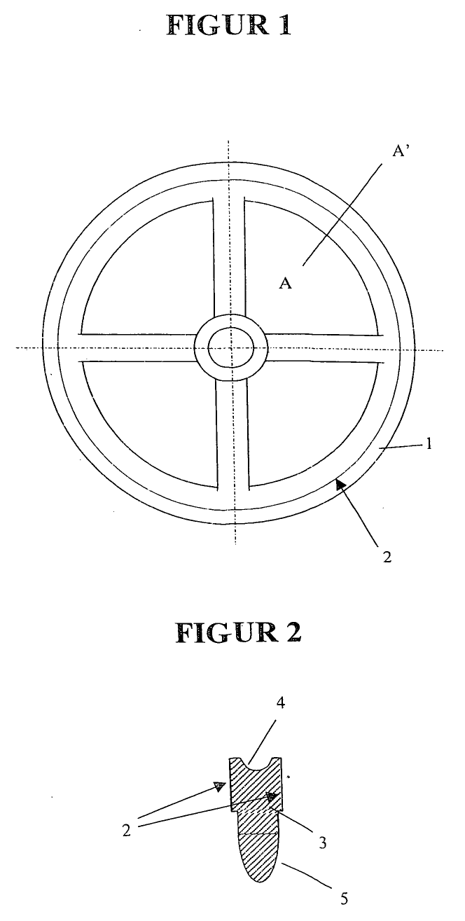

FIG. 1 shows a typical shape of a running wheel rim made of fibre-reinforced plastic.

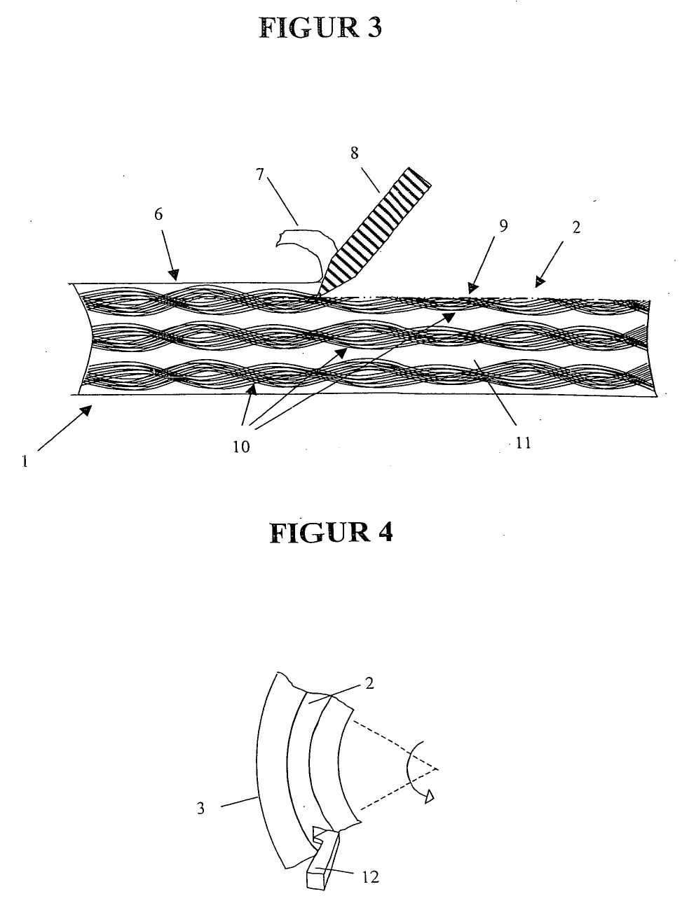

FIG. 2 shows a section through the rim of FIG. 1 having the typical profile following the surface treatment according to the invention.

FIG. 3 shows the typical material quality of the composite material following the primary shaping process in the rim flank prior to and after the treatment according to the invention.

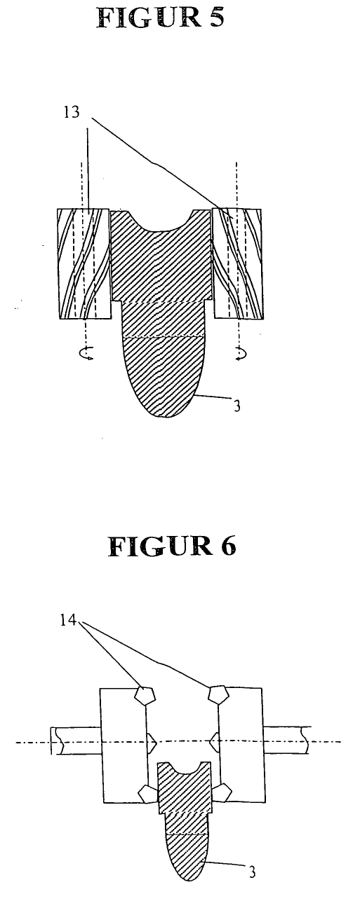

FIG. 4 to FIG. 8 show examples of the treatment of the rim flank according to the invention:

FIG. 4 shows the treatment of the rim set in rotation, using a cutting-chisel tool.

FIG. 5 shows the treatment by 2 axially parallel plain milling cutters with a rotating rim advance.

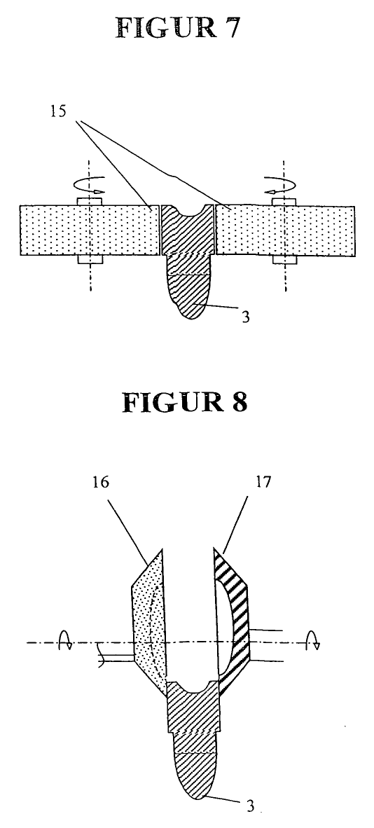

FIG. 6 shows the treatment of the rim flank, using a face milling cutter.

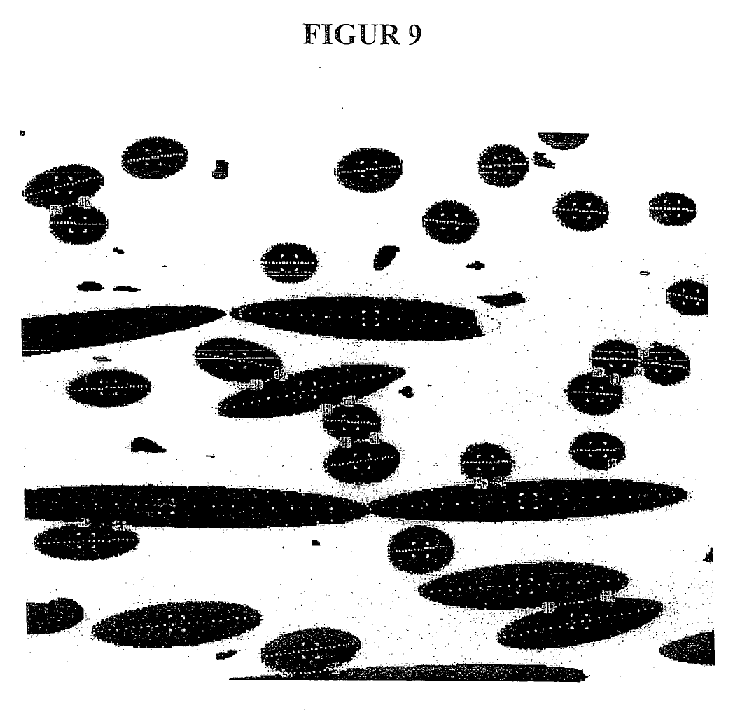

FIG. 7 and FIG. 8 show manufacturing methods with rotating grinding tools:

FIG. 7 shows the treatment with cylinder grinding wheels.

FIG. 8 shows the treatment with cup wheels.

FIG. 9 shows the optical (enlarged) picture of the surface of a braking area of a rim according to the invention, which picture has been processed with the aid of a computer.

The running wheel shape shown in FIG. 1 represents the principal appearance of a running wheel made of fibre composite comprising four moulded-on spokes. The outer ring constitutes the rim 1 which exhibits a transitional region toward the wheel centre, which transitional region is rounded in the normal case, as well as a circumferentially parallel braking area 2 where usually the brake linings are attached. The tyre is mounted on the exterior.

In the embodiment shown in the figures, the rim 1 consists, preferably entirely, essentially of fibre-reinforced plastic.

The section A-A′ is outlined in FIG. 2 and shows the cross-section of the rim. The circumferentially parallel surface of the braking area 2, which surface has been processed according to the invention, is located close to the outer end of the rim flank. The interior 3 of the rim consists of a fibre-reinforced composite material. The tyre is mounted in the guide recess (rim base 4). The radially inner, mostly tapering part of the rim 5 is usually not subjected to mechanical aftertreatment.

In FIG. 3, the basic principle of the treatment according to the invention of the braking area 2 using a cutting tool 8 is illustrated.

The layer configuration made up of a semifinished reinforcing fibre sheet product 10 and a plastic material 11 in the composite material is outlined.

On surface 6 (prior to the treatment), the original model exhibits a layer which consists basically only of the polymer matrix and comprises no or virtually no, respectively, amount of reinforcing fibres. Said layer has inadequate physical properties.

If said layer is now removed with a tool 8 whereby a chip 7 is formed, the reinforcing fibres 10 are exposed and a surface 9 is formed which, as provided according to the invention, comprises an amount of reinforcing fibres of more than 10%. The removal of the material can be continued until a desired amount of reinforcing fibres has been produced.

A few methods of material removal are described below.

FIG. 4 shows the basic arrangement of the treatment of the rim body 3 using a lathe tool 12 which is placed against the direction of rotation on the running wheel body 3 which has been set in rotation and machines the braking area 2, whereby the reinforcing fibres are exposed.

In doing so, the uppermost layer of plastic as well as further layers are removed until a sufficient amount of fibres of the employed semifinished fibre sheet product end up lying on the outside and a surface structure which is constant throughout the circumference of the rim (in the braking area) arises while, at the same time, involving a high circumferential parallelism.

Here, the emphasis lies on the manufacture of a constant rim width (tolerances typically 0.1 mm beyond the total circumference, in the braking area).

Spring-loaded guide rollers in the work area comprising an adjustable limit stop may be used for stabilization and target width adjustment. In rims without a central actuation facility, actuation may also be effected via rolls. The treatment of the two rim flanks can occur simultaneously by means of two lathe tools or consecutively.

FIG. 5 shows the use of plain milling cutters 13 as milling tools. Thereby, the width of the rim body 3 to be treated is gradually reduced throughout the entire circumference by means of two plain milling cutters 15 disposed in a precisely parallel arrangement and comprising a vertical work spindle in the target width distance until the above-mentioned surface properties arise.

FIG. 6 shows a treatment variant using face milling cutters 14, wherein the rotational axis of the milling cutters must be precisely parallel to the rotational axis of the rim body 3 in order to achieve high plane parallelism.

Furthermore, form cutters can be used which, in addition to the shaping of the braking area, also modify the rim profile in a formative manner. Milling machines with a rotary attachment or coordinate milling machines may also be used for the treatment.

FIG. 7 and FIG. 8 show treatment processes using grinding wheels of a suitable granulation, whereby the rim body 3 is ground to the desired width with the intended surface properties. Cylinder grinding wheels 15 or cup wheels 16 (in section 17) of different granulations are suitable, whereby the rotating abrasive wheels are guided onto the rim surface to be treated, resulting in an abrasive shaping with the surface being refined at the same time.

Besides rotating abrasive wheels, oscillating abrasive wheels may also perform the material removal. The movements can turn out to be radial, lateral, revolving or in the shape of an eccentric path.

In the illustration of the surface of a braking area of a rim according to the invention in FIG. 9, the fibre cross-sections exposed by the removal of the material are clearly visible (as dark areas) against the light-coloured polymer matrix. The sections are elliptical to circular. The areas of the fibre sections and therefrom the total amount of fibres on the surface can be calculated from the sectional shapes. In the example of FIG. 9, said amount exceeds by far 10%.

List of Reference Numerals

1 rim
2 braking area
3 rim body
4 rim base
5 rim shape
6 surface of the braking area (prior to the mechanical treatment)
7 chip
8 cutting tool (wedge)
9 mechanically refined surface
10 semifinished reinforcing fibre sheet product
11 plastic material/artificial resin, consolidated base material
12 lathe tool (cutting chisel)
13 plane milling cutter
14 face milling cutter
15 abrasive wheels (cylindrical)
16 abrasive wheels (cup-shaped)
17 section through 16

1. A rim (1) for bicycles and the like, comprising at least one braking area (2) on at least one flank of the rim (1) for placing a braking member, said braking area (2) essentially consisting of fibre-reinforced plastic, characterized in that the surface (9) of the braking area (2) exhibits an amount of reinforcing fibre (10) of more than 10%.

2. A rim according to claim 1, characterized in that the amount of reinforcing fibre (10) amounts to 10% to 90%, preferably 50% to 90%.

3. A rim according to claim 1 or 2, characterized in that the rim (1) comprises, on both flanks, a braking area (2) the surface (9) of which exhibits an amount of reinforcing fibre (10) of more than 10%.

4. A rim according to any of claims 1 to 3, characterized in that the entire rim (1) essentially consists of fibre-reinforced plastic.

5. A rim according to any of the preceding claims, characterized in that the fibre-reinforced plastic is a layered semifinished reinforcing fibre sheet product.

6. A process for the manufacture of a rim (1) according to any of the preceding claims, comprising the steps of:
producing an original model of the rim comprising at least one braking area (2) on at least one flank of the rim, said braking area (2) essentially consisting of fibre-reinforced plastic,
removing the material of the braking area (2) until reinforcing fibres and reinforcing fibre cross-sections (10), respectively, are exposed on the surface (9) of the braking area (2),
optionally removing the material of the braking area (2) further until the desired amount of reinforcing fibres (10) has been achieved on the surface (9).

7. A process according to claim 6, characterized in that the removal of the material of the braking area (2) is effected by cutting processes.

8. A process according to claim 7, characterized in that the removal of the material of the braking area (2) is effected by means of a cutting tool or several identical or different cutting tools or by means of one or several methods selected from the group comprising turning, milling, filing, scraping, grinding, belt grinding, honing, vibratory grinding, super-finishing, lapping, jet cutting or polishing.

9. A process according to any of claims 6 to 8, characterized in that a cutting-chisel-like tool (12) for material removal is guided onto the rotating rim flank (3) in order to remove the material of the braking area (2).

10. A process according to any of claims 6 to 8, characterized in that the material of the braking area (2) is removed by means of one or several counterrotating plain milling cutter(s) (13) or form cutter(s) or one or several face milling cutter(s) (14), with the advance being effected by a relative rotation of the rim (1) toward the tool (13,14).

11. A process according to any of claims 6 to 8, characterized in that the material of the braking area (2) is removed by means of one or several rotating abrasive wheels (15,16), with the advance being effected by a relative rotation of the rim (1) toward the tool (15,16).

12. A process according to any of claims 6 to 11, characterized in that the original model of the rim (1) comprises, on both flanks, a braking area (2) essentially consisting of fibre-reinforced plastic and the material of the braking areas (2) is removed on both sides of the rim.

13. A process according to claim 12, characterized in that the removal of the material of the braking areas (2) is effected such that circumferentially parallel braking areas (2) are formed on the two rim flanks.

14. A process according to any of claims 6 to 13, characterized in that recesses such as, e.g., grooves or furrows are formed in the braking area (2) by additionally removing the material of the braking area (2).

15. The use of a rim (1) according to any of claims 1 to 5 in a single-track or multi-track vehicle driven by muscular power, selected from the group comprising bicycles such as road racing bicycles, mountain, city or tracking bikes or tandems, wheelchairs, pushcarts or wheelbarrows, scooters, tricycles, and/or in motor-driven small or lightweight vehicles selected from the group comprising electric vehicles, solar power vehicles, vehicles for the disabled, mopeds and motor-assisted bicycles.
